(19) United States
(12) Patent Application Publication
(10) Pub. No.: US 2016/0286727 A1
(43) Pub. Date: Oct. 6, 2016

(54) MULTI-CONVEYER SILAGE CART AND METHOD FOR REMOVING SILAGE FROM THE FRONT END OF SAME

(71) Applicant: Precision AG Solutions, LLC, Grant, MI (US)

(72) Inventors: Danny B. Telkamp, Grant, MI (US); Steven A. Shattuck, Grant, MI (US)

(73) Assignee: Precision AG Solutions, LLC

(21) Appl. No.: 14/943,215

(22) Filed: Nov. 17, 2015

Related U.S. Application Data
(60) Provisional application No. 62/143,252, filed on Apr. 6, 2015.

(51) Int. Cl. A01D 90/12; A01D 90/10

(52) U.S. Cl. CPC A01D 90/12; A01D 90/10

(57) ABSTRACT

A multi-conveyer silage cart (100) includes a bed (105) having a plurality of walls (107) and a plurality of beaters (113, 115) for breaking up clumped silage (111) in the bed (105). One or more conveyers (109, 119) are used for transferring silage in the bed from the rear of the bed through the plurality of beaters (113, 115) and out though the side of one of the plurality of walls for deposit or disposal. Thus, a method also includes removing silage from the front end of a multi-conveyer silage cart using a plurality of conveyers and beaters.

### CROSS REFERENCE TO RELATED APPLICATIONS

This application claims priority under 35. U.S.C. §119(e) to U.S. Provisional Application Ser. No. 62/143,252 entitled Multi-Convey Silage Cart and Method for Removing Silage From Front End of Same filed Apr. 6, 2015 and owned by Precision AG Solutions, LLC.

### FIELD OF THE INVENTION

The present invention relates generally to the harvesting and disposal of agricultural products and more particularly to disposing of chopped silage and/or haylage that is removed from farm fields.

### BACKGROUND OF THE INVENTION

Silage is grass or other green fodder compacted and stored in airtight conditions, typically in a silo, without first being dried, and used as animal feed in the winter. More specifically, corn silage is the corn and its stalk that are fermented into a high-moisture feed. It is a popular forage for cows because it is a high energy food source and easily digested. When there is plentiful rain and sunshine in a growing season, the nurtured corn crops will grow and quickly mature. Consequently, farmers can enjoy a relatively early corn silage harvest in those conditions. Similarly, haylage is grass alfalfa that can be used for like purposes.

A safe and efficient corn silage or haylage harvest is not an easy process. First, farmers must check the condition of their equipment before they head to the fields. Also, they sharpen knives on choppers and set knives to chop corn at the correct particle size since the chop length can impact silage or haylage palatability and overall cow health. As harvest draws near, farmers and crop consultants work to carefully evaluate if the corn and/or grass alfalfa is ready for harvest by checking the plant's moisture content. For example, when the corn crop is ready to harvest, farmers use a forage beater to cut stalks at a consistent, predetermined height which is generally about one foot in height. They chop the entire corn plant which includes stalk, cob, husk and kernels. The contents are then placed in a truck or wagon so it can be delivered and piled upon a concrete pad for drying. Some farmers use mechanical processing of whole-plant corn to improve silage quality. Whole plant processing crushes the entire plant through rollers; this can be done in the field during harvest or at the silo. Alternatively, it can be done after ensiling which is the process of preserving green food for livestock in an undried condition in airtight conditions, either in a storage silo or in plastic wrapping, and just prior to feeding. Processing the corn improves starch and fiber digestion in the cow.

The process of chopping the corn and hay and removing it from the field can be very time consuming and labor intensive. Truck beds are often used to contain and transport the silage from the field. Although this process works in practice, it often can be slow and can damage the field as the heavy truck follows the beater though the moist soil.

### SUMMARY OF THE INVENTION

A multi-conveyer silage cart includes a cart bed surrounded by walls having a front and a rear. A first conveyer is positioned on a floor of the cart bed for moving silage from the rear of the cart bed to the front of the cart bed. A first beater is then used for chopping clumped silage moving on the first conveyer while a second beater is positioned below the first beater for chopping the silage from the first chopper. A second conveyer, working as a cross-conveyer, is used for moving the silage from the second beater, and bed, through a wall on the side of the cart for loading and transport.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a front perspective view illustrating the multi-conveyer silage cart off-loading a silage load from its bed into a dump truck in accordance with some embodiments of the invention.

FIG. 2 is a side view illustrating the silage cart and tread support.

FIG. 3 is a rear view illustrating the rear of the silage cart and the tongue and cross-conveyer.

FIG. 4 is a front view illustrating the cross-conveyer folded for transport such that it extends over the front of the bed.

FIG. 5 is a front perspective view illustrating the cross-conveyer folded as in FIG. 4.

FIG. 6 is top view illustrating the cross-conveyer extended so to offload silage as it passes through the first and second chopper.

FIG. 7 is a front view illustrating the cross-conveyer in an extended position as in FIG. 6.

FIG. 8 is a perspective view illustrating the cross-conveyer in an extended position as shown in FIG. 6 and FIG. 7.

FIGS. 9A, 9B, 9C and 9D illustrate various views of two tine and three tine choppers.

FIG. 10 is a perspective view of the silage trailer showing arrangement of three choppers used in the bed.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a multi-conveyer silage cart. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Further, it is expected that one of ordinary skill, notwithstanding possibly significant effort and many design choices motivated by, for example, available time, current technology, and economic considerations, when guided by the concepts and principles disclosed herein will be readily capable of building a multi-conveyer silage cart described herein with minimal experimentation.

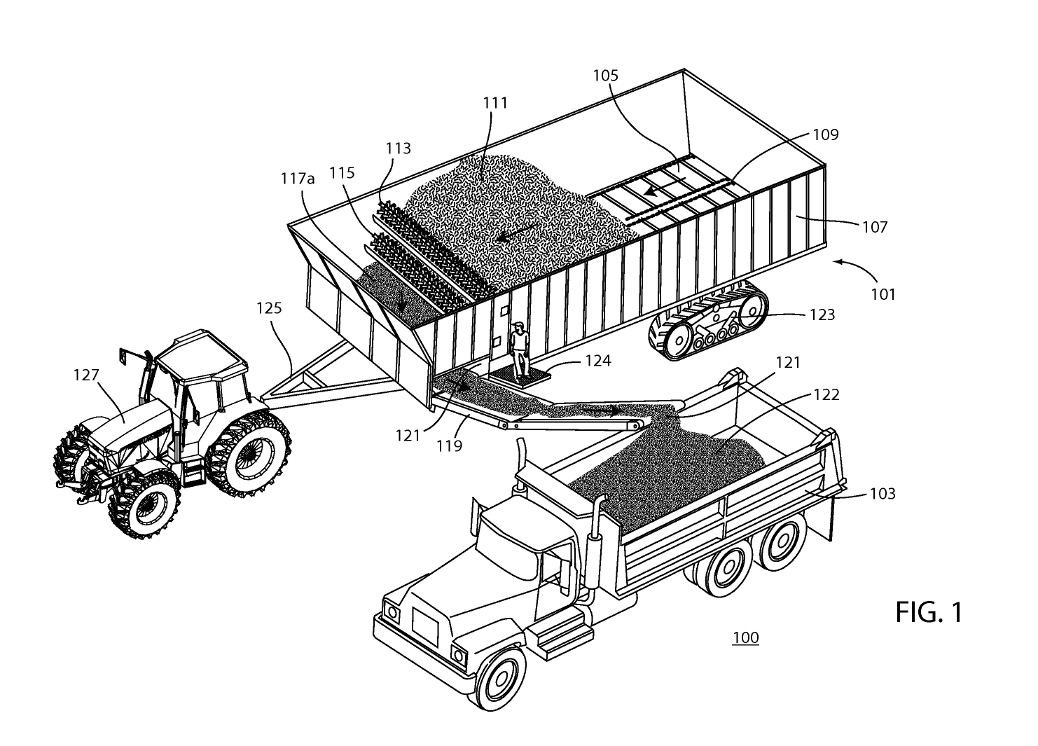

FIG. 1 is a perspective view illustrating the multi-conveyer silage system 100 using a silage cart 101 off-loading a load from its bed into a dump truck 103 in accordance with some embodiments of the invention. Although the term “silage” is used generically throughout, this term also encompasses various types of silage and haylage. As seen in FIG. 1, the silage cart 101 includes a bed 105 surrounded by a plurality of walls 107 that work to contain silage or other agricultural products in the bed 105. The silage cart 101 is elongated and substantially rectangular in shape. A chain apron is configured on the floor of the bed 103 moves in a forward direction i.e. from the rear of the cart to the front of the cart. The chain apron is propelled using a motor and hydraulic drive that forms the first conveyer 109.

As a first conveyer 109 moves the silage 111 in a forward direction, in the bed 103, the silage 111 contacts a first beater 113 and a second beater 115. As described herein, the first beater 113 and second beater 115 might also sometimes be referred to as choppers. Although they do not chop the material the beaters work to create a better flow of material by breaking the silage material apart. The first beater 113 is typically stacked above the second beater 115 or alternatively may be positioned rearward and above the second beater 115. As the silage clumps when moist, the first beater 113 and second beater 115 work to break apart the compressed silage and/or haylage into a finer textured pieces. The first beater 113 works to break apart the taller mound of silage while the second beater 115 breaks apart both the lower silage in the mound while moving along the first conveyer 109 as well as the silage falling from the first beater 113. The chopped silage exits both beaters and then falls into containment area 117 where it can be moved from the bed 103 using a second conveyer 119. Although the beaters are typically unpowered and move according to the silage contacting them, in an alternative embodiment, one of more of the beaters may be powered by an engine to rotate the tines for helping to further break apart clumped silage.

The second conveyer 119 is a cross-conveyer, i.e. operating approximately orthogonally to the first conveyer 109, such that the silage can be moved and/or transported through an opening 121 in a front wall of the silage cart 100. As best seen in FIG. 3, the second conveyer 119 has multiple sections so that it can be either extended into an operating position or folded within the bed 103 for transport. The second conveyer 119 can be raised such that it can move the silage above the silage tailor 101 to eight (8) or more feet in the air to a point 121. This allows the silage to be off-loaded or deposited in the bed 122 of the dump truck 103. An operator platform 124 is configured adjacent to the opening 121 for allowing an operator to monitor and or direct silage along the second conveyer 121. The operator platform is foldable allowing it to be moved against the wall of the cart during transport. Moreover, the platform 124 is sized for allowing an operator to stand outside the wall for viewing both inside the bed as well as viewing offloading silage along the second conveyer 119. Although illustrated in FIG. 1 as positioned on the left side of the silage trailer, those skilled in the art will recognize that second conveyer 119 can be positioned so that silage or haylage can be off loaded on the right side of the trailer as well.

The silage cart 101 is supported using a plurality of multiple wheeled and belted tracks 123. The tracks 123 better distribute weight so that the silage cart 101 when pulled through a wet field without leaving holes or ruts in the soil from heavily loaded wheels. Alternatively, the silage cart 101 can be supported using a plurality of multi-axle wheels having rubber tires. The silage cart 101 is pulled using a tractor 127 or other agricultural vehicle using a V-shaped tongue 123 that is fastened under the bed 105 of the silage cart. In still another embodiment, the tracks or wheels can be removed from the cart so the cart can be lifted onto a vehicular trailer or train car for easy transport.

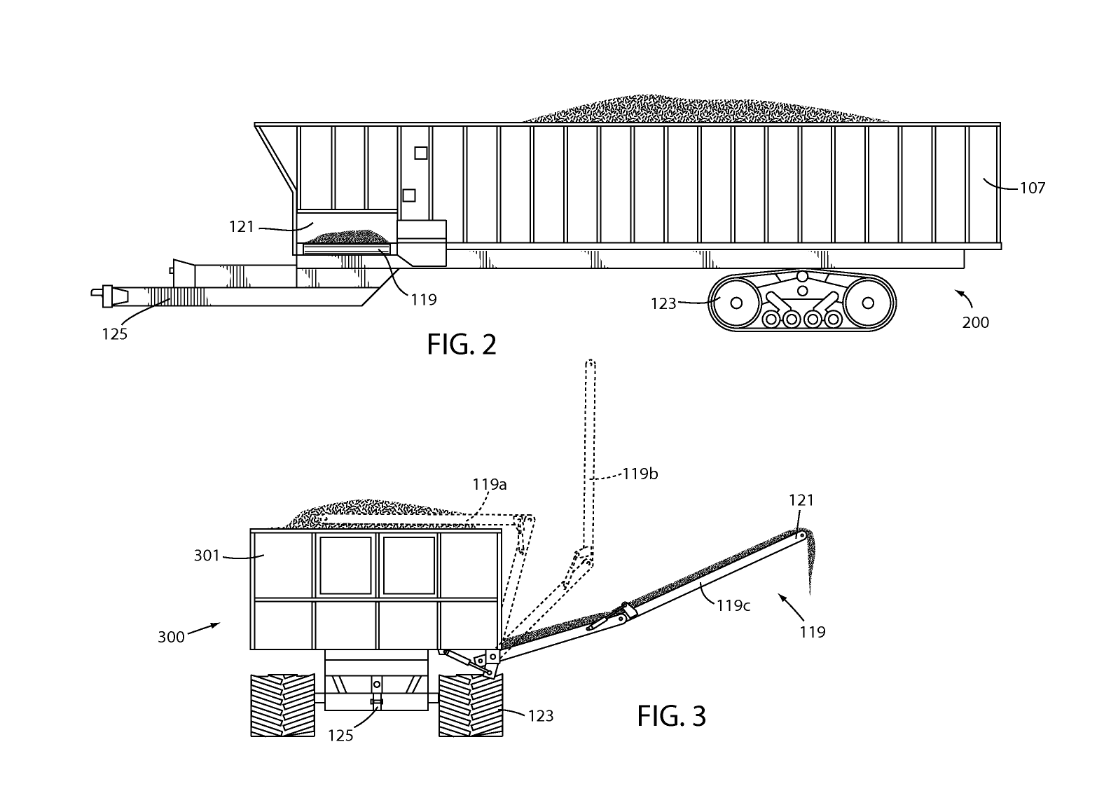

FIG. 2 is a side view illustrating the silage cart 200 and tracks 123. As described herein, the silage is moving though opening 121 by the second conveyer 119 that acts as a cross conveyer to that inside the bed. A tongue 123 is fastened under the front of the silage cart 200 for pulling the cart though a field using a motored vehicle.

FIG. 3 is a rear view illustrating the front of the silage cart 300 and the front wall 301, second conveyer 119 and tongue 125. The second conveyer is segmented into foldable sections 119a, 119b, 119c and 119d so that the conveyer can quickly be extended depending on the distance the silage is to be offloaded to an adjacent vehicle. As noted herein, the second conveyer 119 can be extended upward to point 121 so that silage can easily be off-loaded from the front of the silage cart into a tall vehicle.

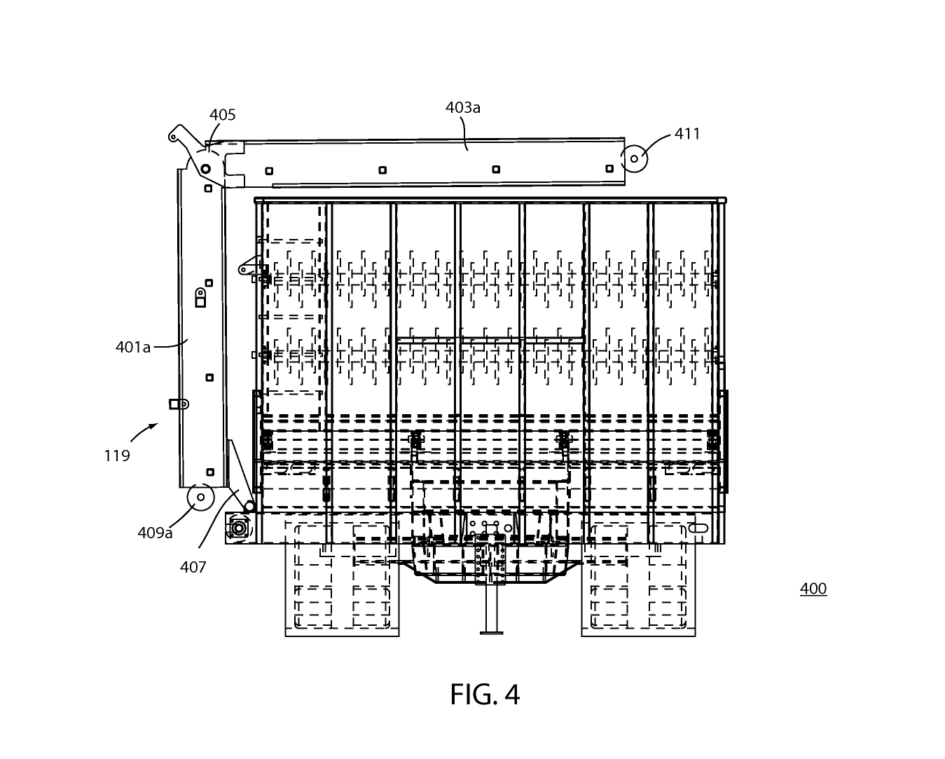

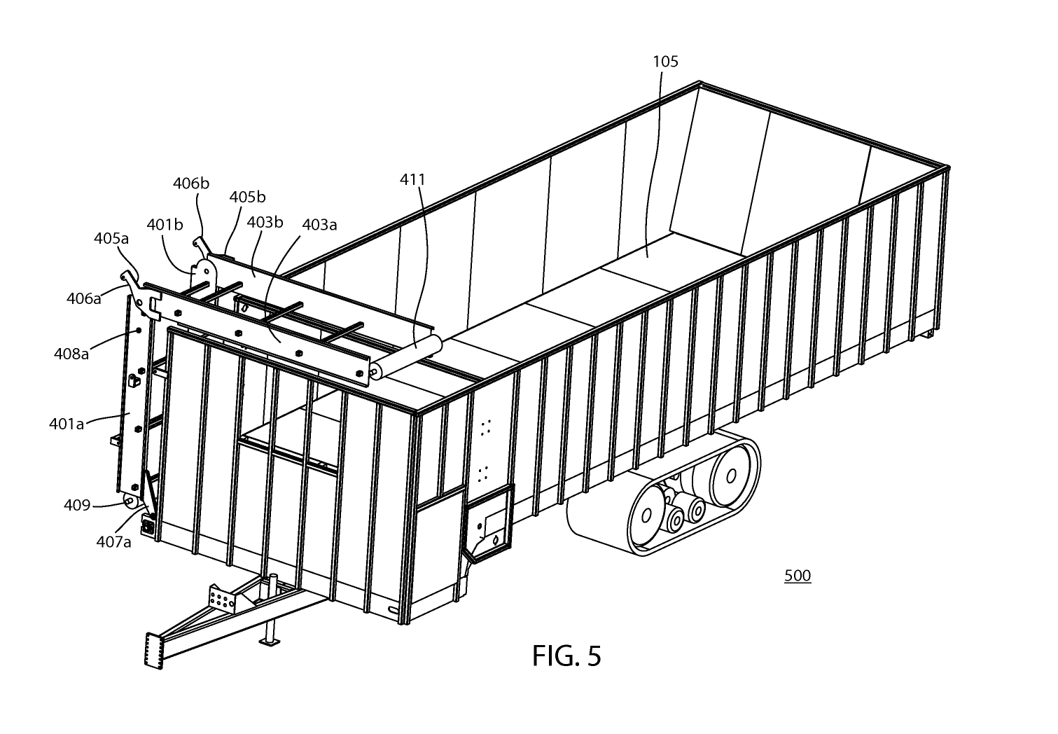

FIG. 4 and FIG. 5 illustrate a front view 400 and a perspective view 500 respectively of the cross-conveyer 119 folded for transport such that it extends over the front of the silage trailer bed 105. The cross-conveyer 119 includes a lower arm having side arm 401a, 401b that are separated by approximately three (3) feet for providing a border for the conveyer surface. An upper arm having side arm 403a, 403b connect with the lower arm using a foldable joint 405a, 405b. The foldable joint 405a, 405b includes a hook 406a, 406b for holding the lower arm and upper arm into a fixed position against a stop 408a, 408b when extended. Brackets, 407a, 407b attach the lower arm to the body of the trailer. Rollers 409, 411 are used for allowing the conveyer surface to roll in a loop like fashion for maintaining continuous motion.

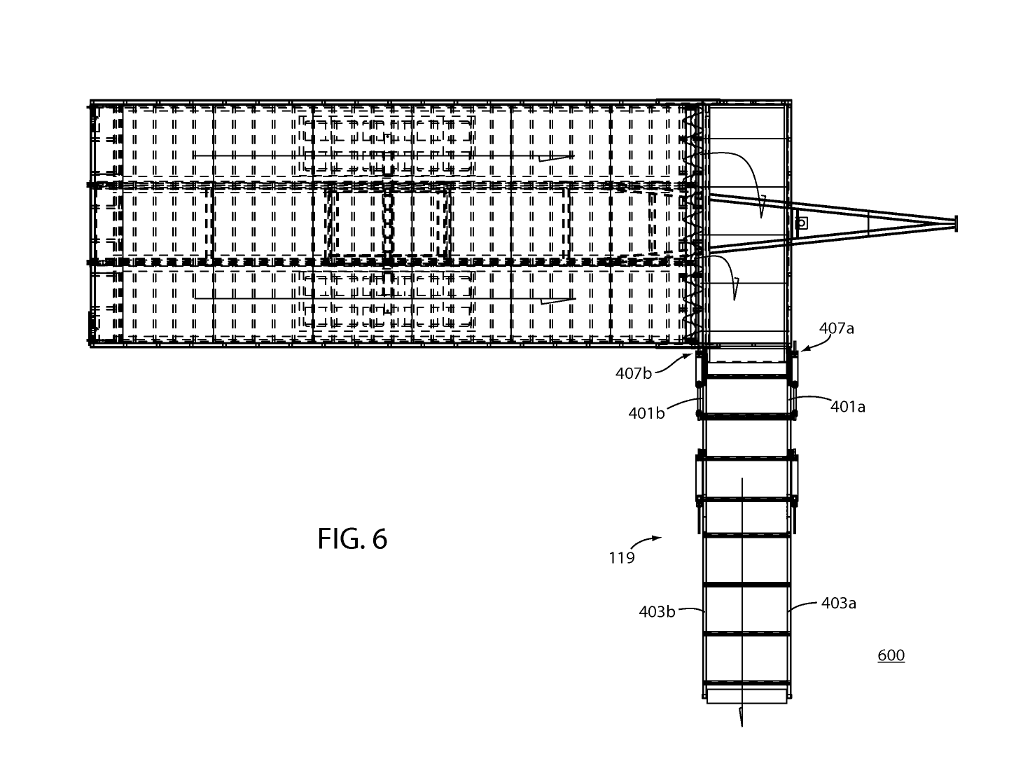

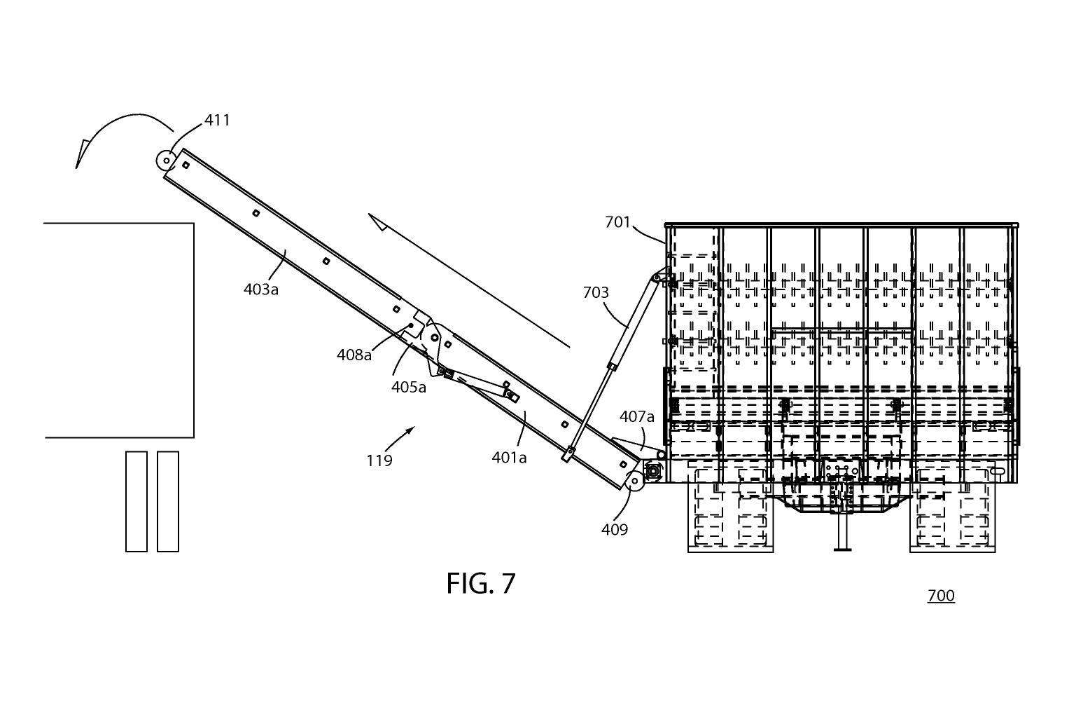

FIG. 6, FIG. 7 and FIG. 8 illustrate a top view 600, front view 700 and perspective view 800 respectively of the cross-conveyer 119 in an extended position. When in an extended position, the cross-conveyer 119 allows silage to be removed from the silage trailer to an adjacent vehicle. FIG. 6 shows the cross-conveyer 119 extended from the right side of the silage trailer where silage is moved by the conveyer in the direction of the arrows. As best seen in FIG. 7 and FIG. 8, the silage is typically elevated by the cross-conveyer so to raise it for dumping into bed of a dump truck park adjacent to the silage trailer. When folded down from the trailer for use, the cross conveyer 119 pivots from brackets 407a, 407b away from the side 701. The motion of the cross-conveyer is damped though the use of a hydraulic piston 703 that is fastened at one end to the trailer side 701 and the opposite end to the side arm 401a. The cross-conveyer 114 is self-supporting so that it can be held over the top of a loading vehicle without being supported at its distal end. Thus, the weight of the cross-conveyer 114 and silage does not bear on the loading vehicle. A conveying belt 801 works to move the chopped silage from the trailer to the loading vehicle such as a dump truck.

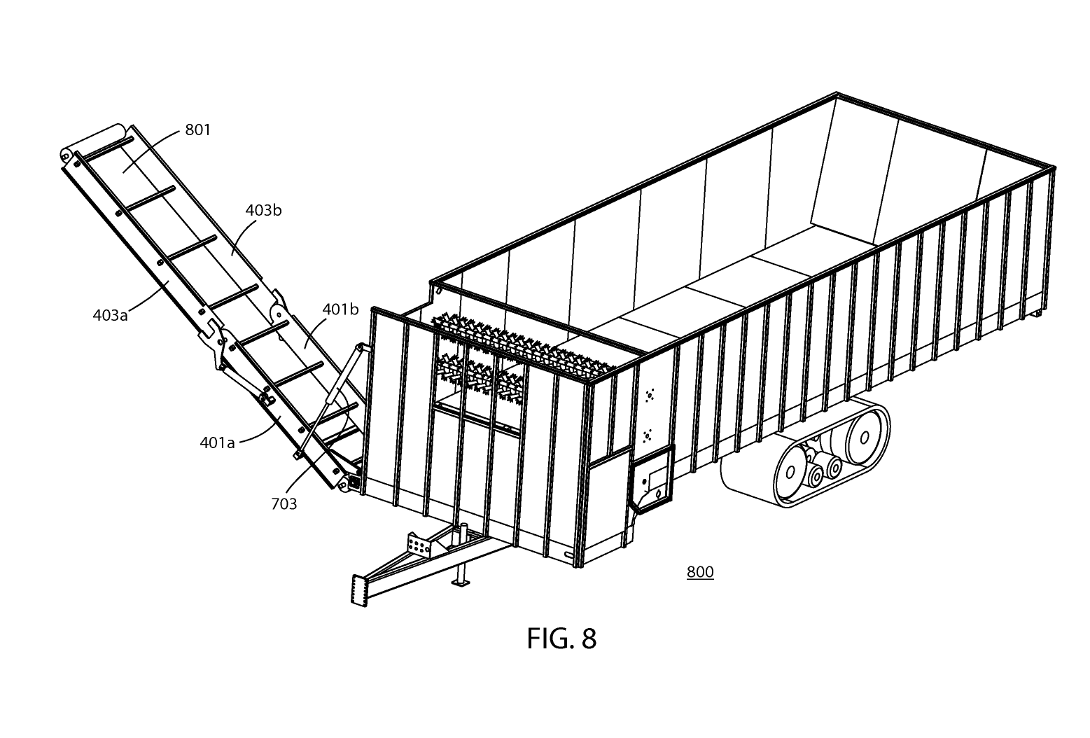

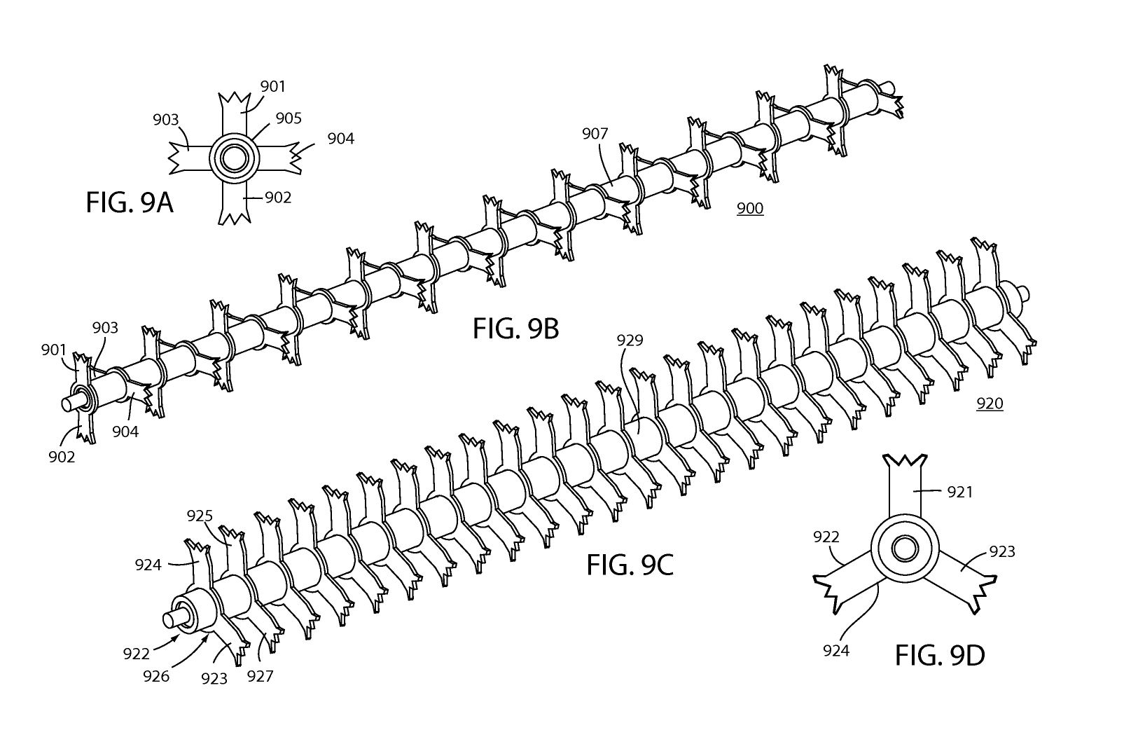

FIG. 9A, FIG. 9B, FIG. 9C and FIG. 9D illustrate various views of two tine and three tine beaters as used in embodiments of the invention. More specifically, FIG. 9A and FIG. 9B show a top view and a perspective view respectively of a two tine beater 900. The beater is referred to as a two tine beater since each beater segment includes two tines 901, 902 aligned 180 degrees apart and joined at hub 905. Each subsequent beater segment is oriented orthogonally with its adjacent segment. For example, the adjacent beater segment to tines 901, 902 are tines 903, 904 that are substantially oriented 90 degrees to tines 901, 902. Each tine 901 includes three prongs having substantially sharped pointed edges for chopping and breaking apart clumped silage. Each set of tines are positioned on a cylindrical shaft 907 and are configured in overall length to mount within the bed of the silage trailer. As described herein, the beater 900 rotates as the conveyer pushes silage in a forward direction to the cart, into the beater.

Similarly, FIG. 9C and FIG. 9D are a top view and perspective view respectively of a three tine chopper. The beater 920 is referred to as a three tine beater since each beater segment includes three tines 921, 922, 923 that are arranged 120 degrees apart in a triangular shape where each is joined at hub 924. As seen in FIG. 9D, each beater segment is aligned with an adjacent segment such that the tines of each segment align in parallel along cylindrical shaft 929. For example, tines 921, 922, 923 will align with tines 925, 926, 927. Each tine 921 includes three prongs having substantially sharp pointed edges for cutting up clumped silage. As noted herein, the cylindrical shaft is sized to fit within the bed of the silage trailer and can rotate as the conveyer pushes silage into the beater 920.

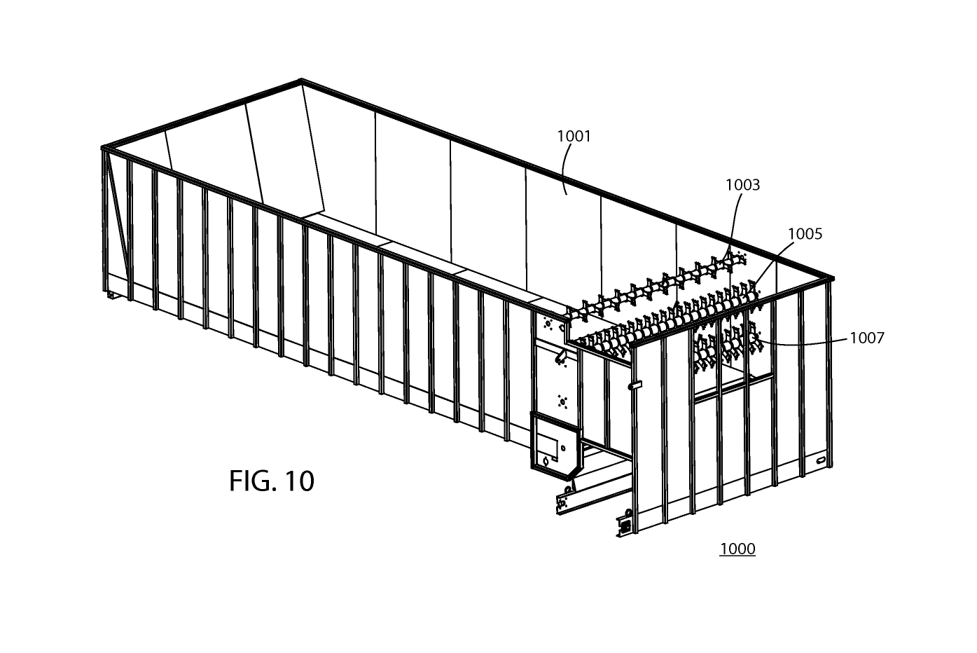

FIG. 10 is a perspective view of the silage trailer showing arrangement of three separate choppers used within the bed. The silage cart 1000 is illustrated having a plurality of side walls 1001, a two tine first beater 1003 is positioned at a high positioned in the front of the bed so that a tall mount of silage moving on the conveyer might contact the first chopper. A second beater 1005 and third beater 1007 are both three tine choppers and are positioned directly below the first beater 1003. The three tine beater operates to cut though the more dense silage as it is pushed forward.

Similar to the apparatus as described herein, a method of removing silage from a silage cart includes the steps of providing a bed having a plurality of walls. Braking apart clumped silage in the bed using at least one beater; and utilizing at least one forward moving conveyer for transferring silage in the bed though the side of one of the plurality of walls for deposit or disposal into an adjacent vehicle or hopper.

Thus, embodiments of the present invention include but are not limited to a multi-conveyer silage cart that comprises a cart bed surrounded by walls having a front and a rear. A first conveyer is configured for moving silage toward the front of the bed in a forward direction. A first beater is used for breaking apart clumped silage moving from the first conveyer where a second beater is positioned below and/or adjacent to the first beater for chopping and breaking up the clumped silage from the first chopper. A second conveyer operates as a cross-conveyer to the first conveyer, for moving the silage from the second beater off the bed in the front of the cart. The silage is removed through a wall on either side of the bed.

In the foregoing specification, specific embodiments of the present invention have been described. However, one of ordinary skill in the art appreciates that various modifications and changes can be made without departing from the scope of the present invention as set forth in the claims below.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A silage cart comprising:
a bed having a plurality of walls;
at least one beater for breaking apart clumped silage material; and
at least one conveyer for transferring silage in the bed though the side of one of the plurality of walls for disposal.

2. A silage cart as in claim 1, further comprising;
a plurality of belted tracks for providing mobile support the silage cart.

3. A silage cart as in claim 1, further comprising:
a plurality of wheels for providing mobile support for the silage cart.

4. A silage cart as in claim 1, wherein the at least one beater is configured using a first beater positioned above a second beater for de-clumping silage in the bed.

5. A silage cart as in claim 1, wherein the at least one conveyer is configured using a first conveyer for moving silage on the floor of the bed and a second conveyer for moving the silage out of the bed.

6. A silage cart as in claim 4, wherein the first conveyer moves silage from the rear of the bed to the at least one beater.

7. A silage cart as in claim 4, wherein the second beater moves the silage form the front of the bed out of a side of the bed.

8. A multi-conveyer silage cart comprising:
a cart bed surrounded by walls having a front and a rear;
a first conveyer on a floor of the cart bed for moving silage from the rear of the cart bed to the front of the cart bed;
a first beater for chopping clumped silage moving on the first conveyer;
at least one second beater positioned below the first beater for chopping the silage from the first chopper; and
a second conveyer for moving the silage from the second beater from the bed through a wall on the side of the bed.

9. A multi-conveyer silage cart as in claim 8, further comprising:
a plurality of tracks for providing support to the silage cart while in motion.

10. A multi-conveyer silage cart as in claim 8, wherein a floor of the cart bed operates as the first conveyer for moving silage toward the first chopper.

11. A multi-conveyer silage cart as in claim 8, wherein the at least one second beater includes a plurality of aligned tines for cutting clumped silage.

12. A multi-conveyer silage cart as in claim 8, wherein the second conveyer raises the silage for dumping into a truck bed.

13. A multi-conveyer silage cart as in claim 8, wherein the second conveyer is foldable for storage in the cart bed.

14. A method for removing silage from a silage cart comprising the steps of:
providing a bed having a plurality of walls;
breaking apart clumped silage in the bed using at least one chopper; and
utilizing at least one forward moving conveyer for transferring silage in the bed though the side of one of the plurality of walls for disposal.

15. A method for removing silage as in claim 14, further comprising the step of:
supporting the silage cart using a plurality of belted tracks.

16. A method for removing silage as in claim 14, further comprising the step of:
supporting the silage cart using a plurality of multi-axle wheels.

17. A method for removing silage as in claim 14, further comprising the step of:
configuring the at least one beater to include a first beater positioned above a second beater for chopping silage in the bed.

18. A method for removing silage as in claim 17 wherein the first beater and second beater include a plurality of tines for cutting clumped silage.

19. A method for removing silage as in claim 14, further comprising the step of:
configuring the at least one conveyer to include a first conveyer for moving silage on the floor of the bed and a second conveyer for moving the silage out of the bed though one of the plurality of walls.

20. A method for removing silage as in claim 14, further comprising the step of:
configuring the second conveyer such that it is foldable for storage within the bed.
